(19) United States
(12) Patent Application Publication
(10) Pub. No.: US 2013/0194395 A1
(43) Pub. Date: Aug. 1, 2013

(54) Method, A System, A Viewing Device and a Computer Program for Picture Rendering

(71) Applicants: Miska Matias HANNUKSELA, Ruutana (FI); Payman AFLAKI, Tampere (FI)

(72) Inventors: Miska Matias HANNUKSELA, Ruutana (FI); Payman AFLAKI, Tampere (FI)

(73) Assignee: NOKIA CORPORATION, Espoo (FI)

(21) Appl. No.: 13/534,485

(22) Filed: Jun. 27, 2012

Related U.S. Application Data
(60) Provisional application No. 61/502,051, filed on Jun. 28, 2011.

(51) Int. Cl. H04N 13/04

(52) U.S. Cl. CPC H04N 13/0445
USPC 348/51

(57) ABSTRACT

A method and technical equipment implementing the method is provided for glasses-based stereoscopic display systems. The solution enables a good stereoscopic viewing quality when viewed with glasses, but also when viewed without glasses. Various aspects of the invention include a method, a system, a viewing device and a non-transitory computer readable medium comprising a computer program stored therein.

### BACKGROUND

Advances in digital video coding have enabled the adoption of video into personal communication such as video telephony over mobile communication networks, capture and sharing of personal digital videos and consumption of video content available in internet services. At the same time, perhaps the most significant breakthrough since the addition of color into moving pictures is happening: moving pictures can be viewed in three dimensions, and from different viewing angles. Again, digital video coding is enabling the adoption of this technology into personal, widespread use.

The Advanced Video Coding (H.264/AVC) standard is widely used through digital video application domains. A multi-view extension, known as Multi-view Video Coding (MVC), has been standardized as an annex to H.264/AVC. The base view of MVC bitstreams can be decoded by any H.264/AVC decoder, which facilitates introduction of stereoscopic and multi-view content into existing services. MVC allows inter-view prediction, which can result in bitrate savings compared to independent coding of all views, depending on how correlated the adjacent views are.

Glasses-based stereoscopic display systems provide a good stereoscopic viewing quality when viewed with glasses, but when viewed without glasses, the perceived quality of the stereo picture or picture sequence is intolerable. Therefore, there is need for a solution that would enable the perceived quality in glasses-based stereoscopic viewing systems acceptable for viewers with and without glasses simultaneously.

### SUMMARY

Now there has been invented an improved method and technical equipment implementing the method as a response to such a need. Various aspects of the invention include a method, a system, a viewing device and a non-transitory computer readable medium comprising a computer program stored therein, which are characterized by what is stated in the independent claims. Various embodiments of the invention are disclosed in the dependent claims.

Many stereoscopic displays require the use of polarizing or shutter glasses. Polarizing glasses may be realized in such a manner that the lenses of polarizing glasses used for stereoscopic viewing have orthogonal polarity with respect to each other. The polarization of the emitted light corresponding to pixels in the display is interleaved. Thus each eye sees different pixels and perceives different pictures. Circular polarization is used in some stereoscopic display systems based on polarization. One view is then polarized clockwise while the other view is polarized counter-clockwise, and the viewing glasses have a respective polarizing filter. Polarized displays may be realized by including a polarizing filter layer on top of the display surface. Polarized projectors may be realized similarly by including a filter in front of the project lens. A silver screen is typically used with a polarization-based projector system to maintain to polarization of the light correctly when it is reflected from the screen.

The shutter glasses are based on active synchronized alternate-frame sequencing. There is a synchronization signal emitted by the display and received by the glasses. The synchronization signal controls which eye gets to see the picture on the display and for which eye the active lens blocks the eye sight. The left and right view pictures are alternated in such a rapid pace that the human visual system perceives the stimulus as a continuous stereoscopic picture.

As was discussed, the glasses-based stereoscopic display systems provide a good stereoscopic viewing quality when viewed with glasses, but the perceived quality of the stereo picture or picture sequence viewed without glasses is intolerable. There might be situations where some of the viewers are wearing glasses and some of the viewers are not, whereby the viewing quality should be good for both of them. By means of the present solution, viewers with glasses may be able to perceive stereoscopic picture, while viewers without glasses may be able to perceive a single-view picture, wherein the perceived quality of both pictures is tolerable.

According to a first aspect there is provided a method comprising receiving a first picture and a second picture, the first picture and the second picture representing a left view and a right view, respectively, for stereoscopic viewing and intended to be rendered for left eye and right eye essentially simultaneously in stereoscopic viewing; determining a dominant view from the left view and the right view and determining a non-dominant view from the left view and the right view, wherein the dominant view and the non-dominant view are not the same; deriving a dominant picture based on the first picture and the second picture and the dominant view, and determining a non-dominant picture based on the first picture and the second picture and the non-dominant view; adapting at least one of the content of or the rendering of at least one of the dominant picture and the non-dominant picture, wherein adapting the content of the dominant picture comprises at least one of the following group: high-pass filtering, upsampling, contrast enhancement, brightness enhancement; and adapting the content of the non-dominant picture comprises at least one of following group: contrast reduction, brightness reduction, low-pass filtering, subsampling, blurring, defocusing, and wherein adapting the rendering of the dominant picture comprises at least one of the following group: increasing the duration and/or frequency of displaying the dominant picture, increasing the number of pixels having a polarization of the dominant view; and adapting the rendering the non-dominant picture comprises at least one of the following group: decreasing the duration and/or frequency of displaying the dominant picture, decreasing the number of pixels having a polarization of the dominant view.

According to an embodiment, the method comprises determining whether adaptation of at least one of the first picture and the second picture is needed.

According to an embodiment, the method comprises rendering the adapted dominant picture and the adapted non-dominant picture essentially simultaneously as a response to determining that adaptation is needed.

According to an embodiment, the method comprises rendering the first picture and the second picture essentially simultaneously as response to determining that no adaptation is needed.

According to an embodiment, the method comprises determining whether the adaptation of at least one of the first picture and the second picture based on a user input.

According to an embodiment, the method comprises determining whether the adaptation of at least one of the first picture and the second picture is done is based on detecting whether viewers wear stereoscopic viewing glasses.

According to an embodiment, the method comprises determining a non-dominant picture comprises synthesizing the non-dominant picture on the basis of at least one of the first picture and the second picture.

According to an embodiment, the method comprises adjusting a disparity between the left view and the right view.

According to a second aspect, there is provided a system comprising receiving means configured to receive a first picture and a second picture, the first picture and the second picture representing a left view and a right view, respectively, for stereoscopic viewing and intended to be rendered for left eye and right eye essentially simultaneously in stereoscopic viewing; determining means configured to determine, a dominant view from the left view and the right view and to determine a non-dominant view from the left view and the right view, wherein the dominant view and the non-dominant view are not the same; and further to derive a dominant picture based on the first picture and the second picture and the dominant view, and determine a non-dominant picture based on the first picture and the second picture and the non-dominant view; adapting means configured to adapt at least one of the content of or the rendering of at least one of the dominant picture and the non-dominant picture, where the adapting means is configured to adapt the content of the dominant picture by at least one of the following: high-pass filtering, upsampling, contrast enhancement, brightness enhancement; and to adapt the content of the non-dominant picture by at least one of following: contrast reduction, brightness reduction, low-pass filtering, subsampling, blurring, defocusing, and where the adapting means is configured to adapt the rendering of the dominant picture by at least one of the following: increasing the duration and/or frequency of displaying the dominant picture, increasing the number of pixels having a polarization of the dominant view; and to adapt the rendering of the non-dominant picture by at least one of the following group: decreasing the duration and/or frequency of displaying the dominant picture, decreasing the number of pixels having a polarization of the dominant view.

According to an embodiment, the determination means are configured to determine whether adaptation of the first picture and the second picture is needed.

According to an embodiment, the system is configured to render the adapted dominant picture and the adapted non-dominant picture essentially simultaneously as a response to determining that adaptation is needed.

According to an embodiment, the system is configured to render the first picture and the second picture essentially simultaneously as response to determining that no adaptation is needed.

According to an embodiment, the determining means for determining whether the adaptation of at least one of the first picture and the second picture is done are configured to operate based on a user input.

According to an embodiment, the system comprises detecting means configured to detect whether viewers wear stereoscopic viewing glasses.

According to an embodiment, the determining means for determining whether the adaptation of at least one of the first picture and the second picture is done are configured to operate according to an input from the detecting means.

According to an embodiment, the system comprises synthesizing means configured to synthesize the non-dominant picture on the basis of at least one of the first picture and the second picture for determining a non-dominant picture.

According to an embodiment, the system comprises adjusting means configured to adjust a disparity between the left view and the right view.

According to a third aspect, there is provided a viewing device comprising at least one processor, memory including computer program code, the memory and the computer program code configured to, with the at least one processor, cause the viewing device to at least: receive a first picture and a second picture, the first picture and the second picture representing a left view and a right view, respectively, for stereoscopic viewing and intended to be rendered for left eye and right eye essentially simultaneously in stereoscopic viewing; determine a dominant view from the left view and the right view and to determine a non-dominant view from the left view and the right view, wherein the dominant view and the non-dominant view are not the same; derive a dominant picture based on the first picture and the second picture and the dominant view, and determine a non-dominant picture based on the first picture and the second picture and the non-dominant view; adapt at least one of the content of or the rendering of at least one of the dominant picture and the non-dominant picture, where adapting the content of the dominant picture by at least one of the following: high-pass filtering, upsampling, contrast enhancement, brightness enhancement; and adapting the content of the non-dominant picture by at least one of following: contrast reduction, brightness reduction, low-pass filtering, subsampling, blurring, defocusing, and where adapting the rendering of the dominant picture by at least one of the following: increasing the duration and/or frequency of displaying the dominant picture, increasing the number of pixels having a polarization of the dominant view; and adapting the rendering of the non-dominant picture by at least one of the following group: decreasing the duration and/or frequency of displaying the dominant picture, decreasing the number of pixels having a polarization of the dominant view.

According to an embodiment, the computer program code is further configured to, with the at least one processor, cause the device to determine whether adaptation of the first picture and the second picture is needed.

According to an embodiment, the computer program code is further configured to, with the at least one processor, cause the device to render the adapted dominant picture and the adapted non-dominant picture essentially simultaneously as a response to determining that adaptation is needed.

According to an embodiment, the computer program code is further configured to, with the at least one processor, cause the device to render the first picture and the second picture essentially simultaneously as response to determining that no adaptation is needed.

According to a fourth aspect there is provided a computer program embodied on a non-transitory computer readable medium, the computer program comprising instructions causing, when executed on at least one processor, at least one apparatus to: receive a first picture and a second picture, the first picture and the second picture representing a left view and a right view, respectively, for stereoscopic viewing and intended to be rendered for left eye and right eye essentially simultaneously in stereoscopic viewing; determine a dominant view from the left view and the right view and determine a non-dominant view from the left view and the right view, wherein the dominant view and the non-dominant view are not the same; derive a dominant picture based on the first picture and the second picture and the dominant view, and determine a non-dominant picture based on the first picture and the second picture and the non-dominant view; adapt at least one of the content of or the rendering of at least one of the dominant picture and the non-dominant picture, wherein adapting the content of the dominant picture comprises at least one of the following group: high-pass filtering, upsampling, contrast enhancement, brightness enhancement; and adapting the content of the non-dominant picture comprises at least one of following group: contrast reduction, brightness reduction, low-pass filtering, subsampling, blurring, defocusing, and wherein adapting the rendering of the dominant picture comprises at least one of the following group: increasing the duration and/or frequency of displaying the dominant picture, increasing the number of pixels having a polarization of the dominant view; and adapting the rendering the non-dominant picture comprises at least one of the following group: decreasing the duration and/or frequency of displaying the dominant picture, decreasing the number of pixels having a polarization of the dominant view.

According to a fifth aspect there is provided a system comprising at least one processor, memory including computer program code, the memory and the computer program code configured to, with the at least one processor, cause the system to at least: receive a first picture and a second picture, the first picture and the second picture representing a left view and a right view, respectively, for stereoscopic viewing and intended to be rendered for left eye and right eye essentially simultaneously in stereoscopic viewing; determine a dominant view from the left view and the right view and determine a non-dominant view from the left view and the right view, wherein the dominant view and the non-dominant view are not the same; derive a dominant picture based on the first picture and the second picture and the dominant view, and determine a non-dominant picture based on the first picture and the second picture and the non-dominant view; adapt at least one of the content of or the rendering of at least one of the dominant picture and the non-dominant picture, wherein adapting the content of the dominant picture comprises at least one of the following group: high-pass filtering, upsampling, contrast enhancement, brightness enhancement; and adapting the content of the non-dominant picture comprises at least one of following group: contrast reduction, brightness reduction, low-pass filtering, subsampling, blurring, defocusing, and wherein adapting the rendering of the dominant picture comprises at least one of the following group: increasing the duration and/or frequency of displaying the dominant picture, increasing the number of pixels having a polarization of the dominant view; and adapting the rendering the non-dominant picture comprises at least one of the following group: decreasing the duration and/or frequency of displaying the dominant picture, decreasing the number of pixels having a polarization of the dominant view.

According to a sixth aspect there is provided a viewing device comprising: receiving means configured to receive a first picture and a second picture, the first picture and the second picture representing a left view and a right view, respectively, for stereoscopic viewing and intended to be rendered for left eye and right eye essentially simultaneously in stereoscopic viewing; determining means configured to determine, as a response to determining that adaptation is needed, a dominant view from the left view and the right view and to determine a non-dominant view from the left view and the right view, wherein the dominant view and the non-dominant view are not the same; and further to derive a dominant picture based on the first picture and the second picture and the dominant view, and determine a non-dominant picture based on the first picture and the second picture and the non-dominant view; adapting means configured to adapt at least one of the content of or the rendering of at least one of the dominant picture and the non-dominant picture, where the adapting means is configured to adapt the content of the dominant picture by at least one of the following: high-pass filtering, upsampling, contrast enhancement, brightness enhancement; and to adapt the content of the non-dominant picture by at least one of following: contrast reduction, brightness reduction, low-pass filtering, subsampling, blurring, defocusing, and where the adapting means is configured to adapt the rendering of the dominant picture by at least one of the following: increasing the duration and/or frequency of displaying the dominant picture, increasing the number of pixels having a polarization of the dominant view; and to adapt the rendering of the non-dominant picture by at least one of the following group: decreasing the duration and/or frequency of displaying the dominant picture, decreasing the number of pixels having a polarization of the dominant view.

In the above aspects, various combinations of the embodiments are possible, for example the first adaptation method may be combined with the second adaption method or may be replaced with the second adaptation method. Similarly, a disparity adjustment may be applied to the embodiments if desired. It is appreciated that more than two embodiments may be combined, too.

### DESCRIPTION OF THE DRAWINGS

In the following, various embodiments of the invention will be described in more detail with reference to the appended drawings, in which

FIG. 1 illustrates an example of stereoscopic view perceived without glasses;

FIG. 2 illustrates a block diagram for a method according to an embodiment;

FIG. 3 illustrates a block diagram for a method according to another embodiment;

FIG. 4 illustrates a block diagram for a method according to yet another embodiment;

FIG. 5 illustrates a block diagram for a method according to yet another embodiment;

FIG. 6 illustrates an example of a view blending method combined to sub-sampling method for image content adjustment;

FIG. 7 illustrates an example of a view blending method for image content adjustment;

FIG. 8 illustrates an example of an adjusted stereoscopic view perceived without glasses;

FIG. 9 illustrates a system and devices for a multi-view video system according to an embodiment; and

FIG. 10 illustrates a viewing device according to an example embodiment.

### DETAILED DESCRIPTION OF THE EMBODIMENTS

In the following, several embodiments of the invention will be described in the context of multi-view video coding and/or 3D video. A variety of display devices providing a 3D experience have been commercialized. Among the 3D display solutions are multi-view autostereoscopic displays, where the views seen depend on the position of the viewer relative to the display, and stereoscopic displays requiring the use of polarizing or shutter glasses as described above.

### Binocular Human Vision

The human vision system (HVS) perceives color images using on the retina of the eye which respond to three broad color bands in the regions of red, green and blue in the color spectrum. HVS is much more sensitive to overall luminance changes than to color changes. The major challenge is understanding and modeling visual perception is that what people see is not simply a translation of retinal stimuli (i.e. the image on the retina). Moreover, HVS has a limited sensitivity; it does not react to small stimuli, is not able to discriminate between signals with an infinite precision, and also present saturation effects. In general one could say it achieves a compression process in order to keep visual stimuli for the brain in an interpretable range.

While presenting a different view for each eye (stereoscopic presentation), the subjective result is usually binocular rivalry where the two monocular patterns are perceived alternately. In particular cases, one of the two stimuli dominates the field. This effect is known as binocular suppression. It is assumed according to binocular suppression theory that the HVS fuses the two images such that the perceived quality is close to that of the higher quality view.

Binocular rivalry affords a unique opportunity to discover aspects of perceptual processing that transpire outside of visual awareness. In stereoscopic presentation, the brain registers slight perspective differences between left and right views (“view” stands for a content that is being/has been captured by camera(s). A view may be a camera view (i.e. captured by a camera) or a synthesized view (i.e. synthesized from camera views and other information) to create a stable, three-dimensional presentation incorporating both views. In other words the visual cortex receives information from each eye and combines this information to form a single stereoscopic image. Left- and right-eye image differences along any one of a wide range of stimulus dimensions are sufficient to instigate binocular rivalry. These include differences in color, luminance, contrast polarity, form, size or velocity. Rivalry can be triggered by very simple stimulus differences or by differences between complex images. Stronger, high-contrast stimuli leads to stronger perceptual competition. Rivalry can even occur under dim viewing conditions, when light levels are so low they can only be detected by the retina's rod photoreceptors. Under some conditions, rivalry can be triggered by physically identical stimuli that differ in appearance owing to simultaneous luminance or color contrast.

### View Synthesis

Depth-image-based rendering (DIBR) or view synthesis refers to generation of a novel view based on one or more existing/received views. Depth images may be used to assist in correct synthesis of the virtual views. Although differing in details, most of the view synthesis algorithms utilize 3D warping based on explicit geometry, i.e. depth images, where typically each texture pixel is associated with a depth pixel indicating the distance or the z-value from the camera to the physical object from which the texture pixel was sampled. One known approach uses a non-Euclidean formulation of the 3D warping, which is efficient under the condition that the camera parameters are unknown or the camera calibration is poor. Yet one other known approach, however, strictly follows Euclidean formulation, assuming the camera parameters for the acquisition and view interpolation are known. Yet in one other approach, the target of view synthesis is not to estimate a view as if a camera was used to shoot it but rather provide a subjectively pleasing representation of the content, which may include non-linear disparity adjustment for different objects.

Occlusions, pinholes and reconstruction errors are the most common artifacts introduced in the 3D warping process. These artifacts occur more frequently in the object edges, where pixels with different depth levels may be mapped to the same pixel location of the virtual image. When those pixels are averaged to reconstruct the final pixel value for the pixel location in the virtual image, an artifact might be generated, because pixels with different depth levels usually belong to different objects.

A number of approaches have been proposed for representing depth picture sequences, including the use of auxiliary depth map video streams, multiview video plus depth (MVD) and layered depth video (LDV). The depth map video stream for a single view can be regarded as a regular monochromatic video stream and coded with any video codec. The essential characteristics of the depth map stream, such as the minimum and maximum depth in world coordinates, can be indicated in messages formatted according to the MPEG-C Part 3 standard. In the MVD representation, the depth picture sequence for each texture view is coded with any video codec, such as MVC. In the LDV representation, the texture and depth of the central view are coded conventionally, while the texture and depth of the other view are partially represented and cover only the dis-occluded areas required for correct view synthesis of intermediate views.

The detailed operation of view synthesis algorithms depend on which representation format has been used for texture views and depth picture sequences.

### Picture Rendering

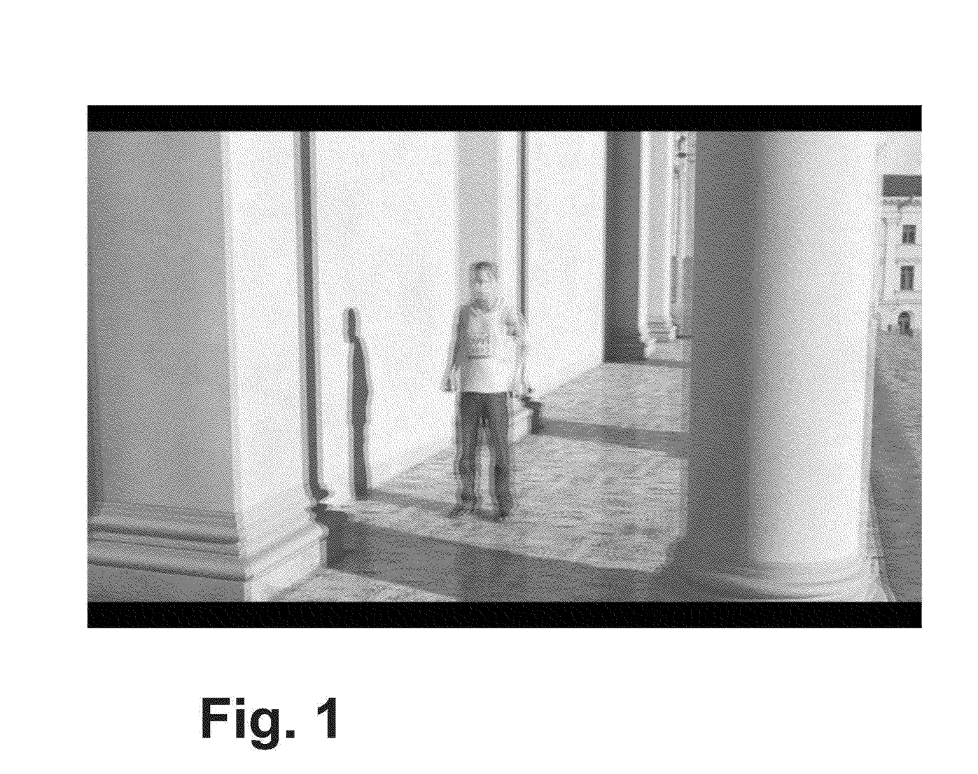

FIG. 1 presents a stereoscopic image displayed on polarizing or shutter glass based display and perceived without glasses. An annoying shadow or ghost image can be observed. It is understood that the perceived quality of the stereo picture or picture sequence viewed without glasses is intolerable compared to when viewed with glasses.

However, there might be situations where there are viewers with and without glasses. For example, in many cases, viewing of the television is not active, but the television is just being kept on as a habit. The television may be located in a central place of a home, where many family members are spending their free time. Consequently, there might be viewers actively watching the television with glasses and simultaneous viewers primarily doing something else (without glasses) and just momentarily peeking the television. Furthermore, the price of the glasses, particularly the active ones, might constrain the number of glasses households are willing to buy. Hence, in some occasions, the households might not have a sufficient number of glasses for family members and visitors watching the television.

The solution being described next aims to make the perceived quality in glasses-based stereoscopic viewing systems acceptable for viewers with and without glasses simultaneously. Viewers with glasses should be able to perceive stereoscopic pictures, while viewers without glasses should be able to perceive single-view pictures.

In the solution, the tradeoff between stereoscopic viewing with glasses and single-view viewing without glasses (i.e. viewing of stereoscopic content without wearing glasses on a display system being operated on stereoscopic mode for glasses-based stereoscopic viewing) may be adaptively adjusted based on e.g. user input. Several adaptation methods will described, taking advantage of the binocular suppression theory being described above. The aim of these adaptation methods is to have a dominant view to be perceived clearly, and the ghost/shadow image caused by a non-dominant view to be close to imperceptible in viewing without glasses, while the perceived quality in viewing with glasses should not be sacrificed much. The adaptation methods fall into two categories: (1) image content adaptation and (2) display configuration adaptation. The adaptation methods are described in more detailed later.

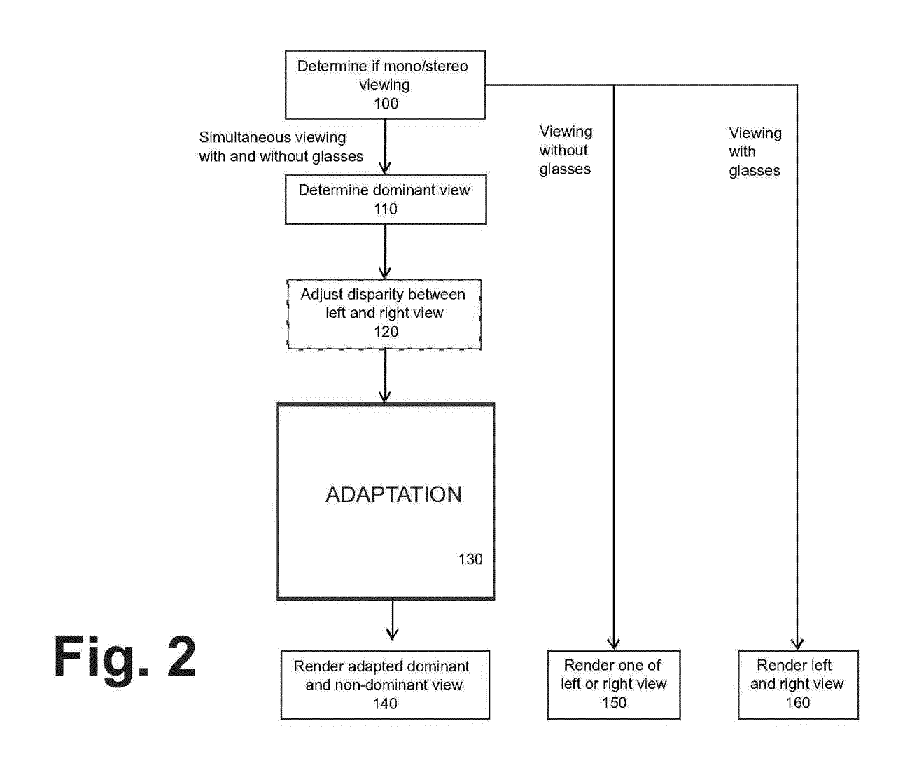

FIG. 2 illustrates an example of an embodiment as a high-level block diagram. The solution may begin by determining (100) how the stereoscopic content is being viewed. The determination between single-view and stereoscopic viewing (100) can be done by various means, including but not limited to the following. A user may manually select the viewing mode: single-view (viewers without glasses), stereoscopic view (viewers with glasses) or mixed single-view and stereoscopic (viewers without and with glasses). As an option to the manual selection, the use of glasses for viewing may be detected. In such detection, the viewing device (that performs the process of FIG. 2) and the viewing glasses can be paired in their configuration phase. In other words, the viewing device may have information which particular glasses can be used with it. When the glasses are turned on for stereoscopic viewing, they can notify the viewing device that they are active e.g. by emitting an infrared single or transmitting through a proximity radio connection. The viewing device can then select a single-viewing mode if no glasses are detected to be active. If glasses are detected to be active, the viewing device may select the mixed single-view and stereoscopic viewing mode or try to conclude if there are viewers without glasses. The viewing device may be equipped with one or more cameras pointing to the direction of viewers and essentially covering the entire viewing angle. Detection of human observes may be done from the images of the one or more cameras. Various methods can be used for detecting human observes, e.g. based on face detection. In addition to detecting human observes, it should be detected whether they wear stereoscopic viewing glasses or not. The number of observers wearing glasses may be determined from the images, as described earlier, while rest of the observers can be considered not wearing the glasses. Alternatively, there can be a computer-vision-based system for detecting users with and without stereoscopic viewing glasses.

The determination of the viewing mode can then be based on the number of viewers with and without stereoscopic viewing glasses. If no viewer is wearing stereoscopic viewing glasses, only one of the left or right views may be rendered (150). If all viewers are wearing stereoscopic viewing glasses, both left and right views may be rendered (160). If some viewers are wearing glasses, while others are not (or if some viewers might wear glasses while others might not), the steps 110 to 140 may be processed.

In step 110, one of the views—left view or right view—is selected to be a dominant view, while the other one is a non-dominant view. The determination between the dominant view can be done by various means, including but not limited to the following. The dominant view may be pre-determined and constant. The dominant view may be signaled within the content or metadata associated with the content. For example, the base view of a coded MVC bitstream may be regarded as an indication of the base view to be selected as the dominant view. The metadata associated with the content may comprise but is not limited to the file format metadata, such as timed metadata tracks and/or boxes of the ISO Base Media File Format, media properties signaling through the Session Description Protocol (SDP), and various descriptors that may be included in the MPEG-2 Transport Stream. It is also possible that the user manually selects which view is dominant e.g. in the configuration settings of the viewing device. As one option, it is also possible to alternate the dominant view as a function of time. The switch of the dominant view from the left view to the right view or vice versa may happen at a scene cut position in order to make it hardly perceivable. The alternation of the dominant view may reduce the amount of discomfort and fatigue in stereoscopic viewing with glasses.

After the dominant view has been determined (110), the disparity between the left and right view may be adjusted (120). This step 120 is optional and may also be skipped, whereupon the disparity between the left and right view may remain unaltered. Whether or not to perform the disparity adjustment between the left and right view in step 120 may be manually controlled by a user or determined using an algorithm. The determination algorithm may be based on signaled or estimated maximum absolute disparity or maximum range of disparity (i.e. minimum negative disparity and maximum positive disparity). The disparity signaling may be done using the multiview scene information SEI (Supplemental Enhancement Information) message of the MVC standard, for example. The determination algorithm may also be based on signaled camera parameters and/or depth ranges. Furthermore, the determination algorithm may be based on the content, e.g. analysis of how visible the disparity difference is in the viewing without glasses. Furthermore, the determination algorithm may take into the estimated distance and position of the viewers (with respect to the display) into account. The distance and position can be estimated by various means including but not limited to camera based methods, where the viewing device may be equipped with one or more cameras pointing to the direction of viewers, and active methods, in which one of the viewing device or the glasses emit a signal, such as an infrared signal, and the other one of the viewing device or the glasses detect the signal. An active methods, the distance and position may be based, for example, on phase difference of the signal, time-of-flight, or direction of arrival estimation based on multiple detectors. The determination algorithm may use the distance and position of the viewers to estimate the subjective perception of the disparity.

The amount of disparity adjustment in step 120 may likewise be manually controlled or automatically determined using an algorithm based on signaled or estimated maximum absolute disparity or maximum range of disparity, signaled camera parameters, signaled depth range, or content analysis.

The disparity adjustment (120) can be considered to control the width of the shadow image. In the disparity adjustment (120), the disparity is typically reduced compared to that provided by the camera views, i.e., the width of the shadow image is reduced compared to that produced by the camera views. In the disparity adjustment (120), the number of pixel perceived as ghosts in the single-view viewing without glasses can be reduced by decreasing the disparity between the left and right views. Consequently, the depth range perceived in stereoscopic viewing also gets smaller. The disparity adjustment (120) can be realized in practice by applying various view synthesis methods.

The disparity adjustment (120) can preferably be done by leaving the dominant view unaltered and synthesizing a new view to replace the non-dominant view in rendering. Any view synthesis algorithm may be used. Some examples of the view synthesis have been described above.

The amount of disparity change can be determined based on various means including but not limited to the estimated perception the pictures resulting from the adaptation method (130) and rendering (140), when viewed with and without glasses, the share of viewers with and without glasses as described below, the estimated position and distance of the viewers determined as described above, and the disparity of the camera views of the content.

In some embodiments, the disparity adjustment (120) may adjust the disparity based on the proportional share of viewers with and without glasses. For example, if a majority of viewers is not wearing glasses, the disparity may be adjusted so that the distance between the camera of the dominant view and the virtual camera of the synthesized view is relatively small but still sufficient to provide a 3D perception for the users wearing glasses. Likewise, if a majority of users are wearing glasses, the disparity might be reduced only a small amount compared to the camera views.

The disparity adjustment (120) may also include or be composed of a “global” disparity adjustment which is equal to each sample of the picture of one view and may be complemented by a “global” disparity adjustment of the other view. Such “global” disparity adjustment is essentially the same as selecting a display rectangle from the left and right view pictures. It may be accompanied with resampling in order to meet the spatial resolution of the display. “Global” disparity adjustment changes the perception on the depth level of objects and may be used to move the perceived 3D scene towards the viewers or towards the display.

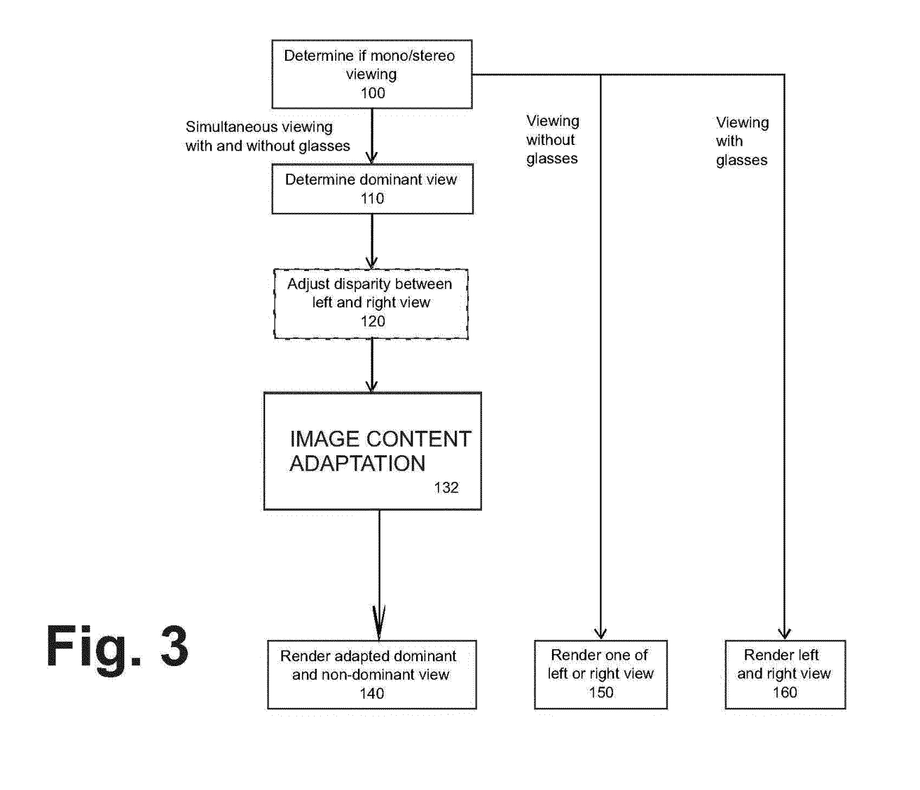

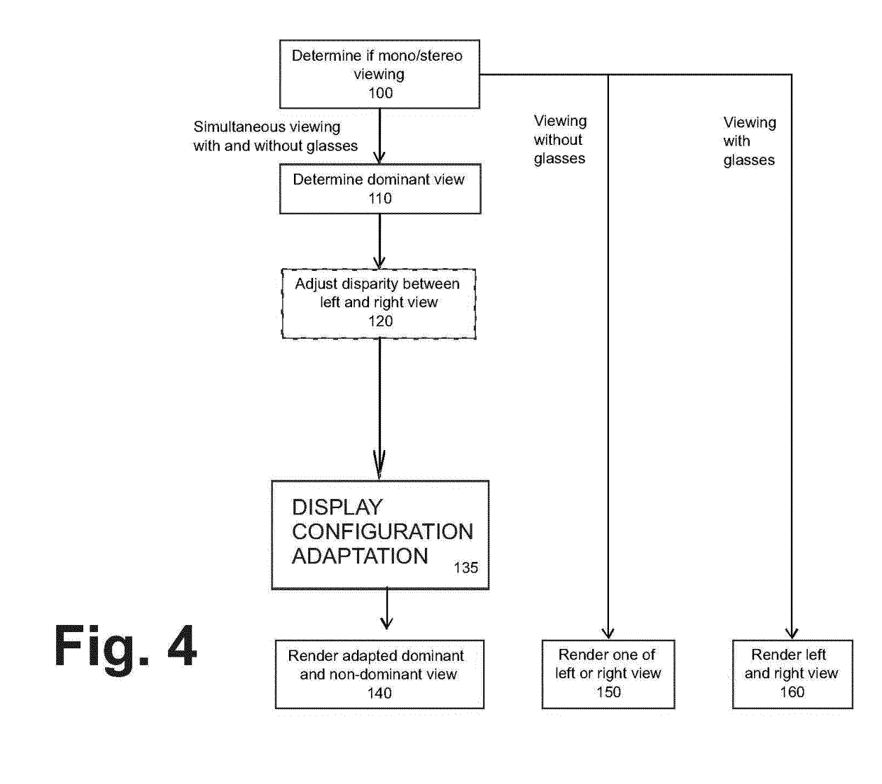

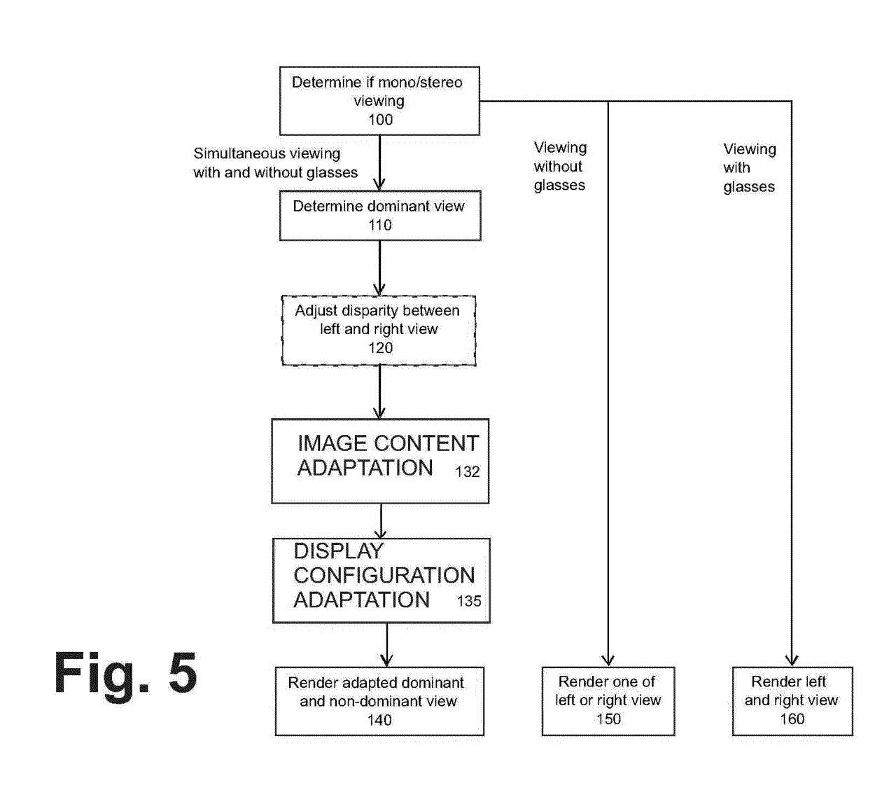

The disparity adjustment (120), when performed, is followed with an adaptation method (130). The adaptation method (130) can consist of either image content adaptation (132) (FIG. 3) or display configuration adaptation (135) (FIG. 4) or both (FIG. 5). In image content adaptation (132), the contents of the dominant and/or non-dominant views are changed using one or more of the adaptation methods being described later. In display configuration adaptation (135), the display configuration is changed to favor dominant view at the expense of the non-dominant view. For example, when shutter glasses are used, the dominant view may be displayed longer and/or more frequently than the non-dominant view. Both adaptation methods will be described in more detailed manner later.

After the adaptation (130), the adapted dominant and non-dominant views may be rendered (140). In addition to or instead of rendering (140), the adapted dominant and non-dominant views may be transmitted to another device, for example using wireless communications means, and the another device may render the dominant and non-dominant views. Furthermore, in addition to or instead of rendering (140), the adapted dominant and non-dominant views may be compressed and/or stored into a file, and may be decompressed and/or rendered later.

In the following, the adaptation methods (130: 132, 135) will be described. As said, the adaptation method (130) may consist of either image content adaptation (132) or display configuration adaptation (135) or both.

### (1) Image Content Adaptation (132)

In the image content adaptation (FIG. 3) the aim is to keep the appearance of the stereo pair (i.e. a picture from the left view and a picture from the right view displayed essentially at the same time such a way that they are perceived as a stereoscopic image) similar as originally in viewing with glasses, while the dominant and non-dominant view are made distinct and imperceptible, respectively, for viewing without glasses.

In this adaptation method, the pictures in dominant view may be adapted such a manner that they dominate in the binocular rivalry in stereoscopic viewing and the dominant view is the main perceived view in single-view viewing without glasses. The non-dominant view may be adapted such a manner that the “ghost image” perceived in single view viewing without glasses becomes hardly perceivable, while binocular fusion still produces three-dimensional vision. The adaptation methods may include one or more of the following:
a) Contrast and brightness adjustment, where the contrast and/or brightness of the non-dominant view is decreased, and the contrast and/or brightness of the dominant view is increased.
b) Subsampling/halftoning, where the number of pixels of the non-dominant view is decreased.
c) View blending, where the content of the non-dominant view is slightly adjusted towards the content of the dominant view.
d) Low-pass filtering/downsampling/blurring, where the sharpness/focus of the non-dominant view is decreased.
   The operation of some adaptation methods takes only a single view as an input, whereas other adaptation methods take both views into account and adjust a view adaptively based on the contents of the other view. The adaptation methods are now described in more detail:

### (a) Contrast/Brightness Adjustment

This method relates to “contrast adjustment”. Contrast can be defined to be the difference in visual properties that makes an object or its representation in an image distinguishable from other objects and the background. In visual perception of the real world, contrast is determined by the difference in the color and brightness of the object and other objects within the same field of view. Various mathematical definition of contrast are used in different situations. In the following, luminance contrast is used as an example, but the formulas can also be applied to other physical quantities. In many cases, the definitions of contrast represent a ratio of the type

$$\frac{Lumimance difference}{Average difference} .$$

The rationale behind this is that a small difference is negligible if the average luminance is high, while the same small difference matters if the average luminance is low. Below, some common definitions are given.

Weber contrast:

$$\frac{I - {I}_{b}}{{I}_{b}} ,$$

where I represents the luminance of the features and I_{b} represents the background luminance. It is commonly used in cases, where small features are present on a large uniform background, i.e. the average luminance is approximately equal to the background luminance.

The Michelson contrast is commonly used for patterns where both bright and dark features are equivalent and take up similar fractions of the area. The Michelson contrast is defined as

$$\frac{{I}_{max} - {I}_{min}}{{I}_{max} + {I}_{min}} ,$$

where Iₘₐₓ represents the highest luminance and Iₘᵢₙ represents the lowest luminance. The denominator represents twice the average of the luminance.

RMS (Root Mean Square) contrast does not depend on the spatial frequency content or the spatial distribution of contrast in the image. RMS contrast is defined as the standard deviation of the pixel intensities:

$$\sqrt{\frac{1}{MN} {\sum }_{i = 0}^{N - 1} {\sum }_{j = 0}^{M - 1} {( {I}_{ij} - \overline{I} )}^{2}} ,$$

where intensities Lᵢⱼ are the i:th and j:th element of the two-dimensional image of size M by N. Ī is the average intensity of all pixel values in the image. The image I is assumed to have its pixel intensities in the range [0, 1].

Now, when dissimilar views are presented to the two eyes, they compete for perceptual dominance so that each image is visible in turn for a few seconds while the other is suppressed.

Considering that binocular rivalry favors the view with higher contrast, by decreasing and increasing the contrast of non-dominant and dominant view, respectively, a 2D presentation of stereoscopic view can be achieved which has more similarity to dominant view while stereoscopic presentation is presumably not influenced considerably.

The contrast adjustment of an image for the image content adaptation can be done in various ways. Any contrast adjustment method can be used with the present solution, such as “linear luminance value range adjustment with saturation”. This contrast adjustment method has two phases: 1) scaling the luma values of pixels and 2) saturating the interim luma values resulting from the phase 1 to a desired range.

If the dynamic range of the luma values of the input image is [y₁, y₂], the contrast can be increased by increasing the dynamic range of the luma values and decreased by decreasing the value range.

The adjustment of the dynamic range can be done such a way that the average brightness of the image stays unchanged or the brightness may be changed simultaneously. The average brightness, denoted by “b”, can be found for example by summing up the luma component values of all pixels of the input image first and then dividing that by the number of pixels. Let us denote the luma value of an input pixel by “i” and contrast adjustment factor by “f”. When the average brightness is kept unchanged, the output luma value of the pixel “o” can be computed as follows: o=(i−b)×f+b. When the average brightness is modified, the value of “b” in the equation above can be chosen to be something else than the average brightness.

In another approach, a different adjustment factor may be used for luma values above “b” than for luma values below “b”.

Typically, the output values can also be quantized (e.g. to integer values) and saturated or clipped to a certain output range. When 8-bit color component representation is used, the saturation range may be [0, 255].

In another example, the darkest and brightest levels of the image may be kept unchanged, i.e. the saturation range can be selected to be [y₁, y₂]. The contrast adjustment factor or factors may be selected such a manner that e.g. 1% of data on lower and higher luma values (2% in total) of the image are saturated.

Histogram equalization modifies the contrast of images by transforming the values in an intensity/luminance image so that the histogram of the output image approximately matches a specified histogram. The desired output histogram may be selected adaptively on the basis of the histogram of the input image. The histogram equalization may also be done on sub-image basis.

### (b) Subsampling/Halftoning

Halftoning is a technique that can be used to simulate continuous-tone imaging through the use of dots, varying in spacing. When digital halftoning is applied to an image or bitmap, a pixel may be tuned on or off in the output image. Halftoning is typically applied cell-wise where each cell contains the same amount of pixels. Where continuous tone imagery contains an infinite range of colors or grays, the halftone process reduces visual reproduction to a binary image that is printed with only one color. This binary reproduction relies on the limited capability of the human visual system on perceiving spatial frequency changes as well as a basic optical illusion that these tiny halftone dots are blended into smooth tones by the human eye. At a microscopic level, developed black and white photographic film also consists of only two colors, and not an infinite range of continuous tones. Halftoning can also be generalized such a manner that the output image can contain more than two, but a non-continuous range of levels of colors or greys.

Halftoning may result into false edges or “banding” (stepwise rendering of smooth gradations in brightness or hue). To avoid banding, dithering can be used to add intentional noise to the output signal to randomize the quantization error caused by the halftoning process. Several methods for image dithering have been proposed, including families of ordered dithering and error-diffusion dithering methods.

If subsampling or halftoning was applied for the non-dominant view, some of the pixel positions in the non-dominant view became unused, i.e. are set to zero luma level. An additional step can be performed to adjust the non-dominant view by filling the unused pixel positions smoothly using some information from dominant view.

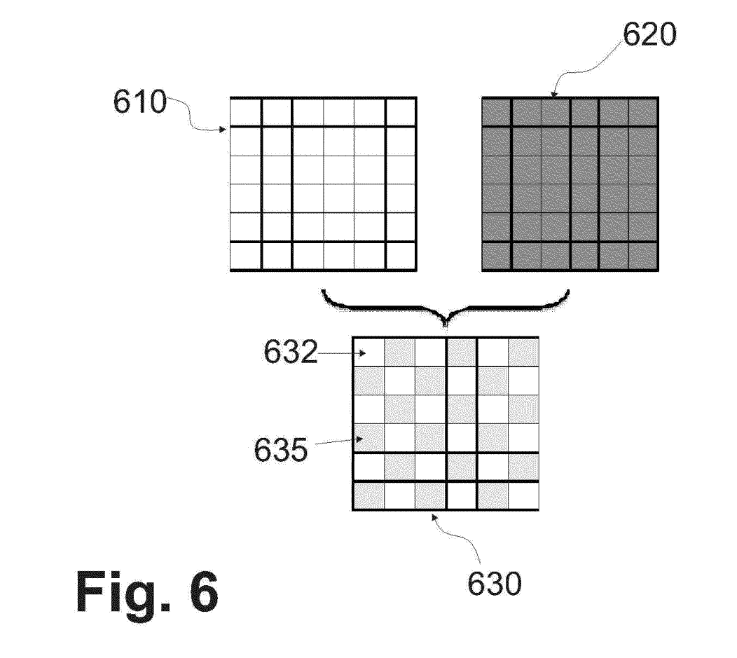

In this approach, shown in FIG. 6, non-dominant view 610 is read row-by-row. Dominant view is referred by 620. Along each even row of non-dominant view 610, the odd pixel values will be replaced by their average value with the same pixel value in the dominant view as presented by a subsampled non-dominant view 630. The subsampled non-dominant view 630 is composed of the same pixel values as non-dominant view 632 and average values between non-dominant and dominant pixel values 635. For odd rows replacement will be applied to even pixels.

### c) View Blending

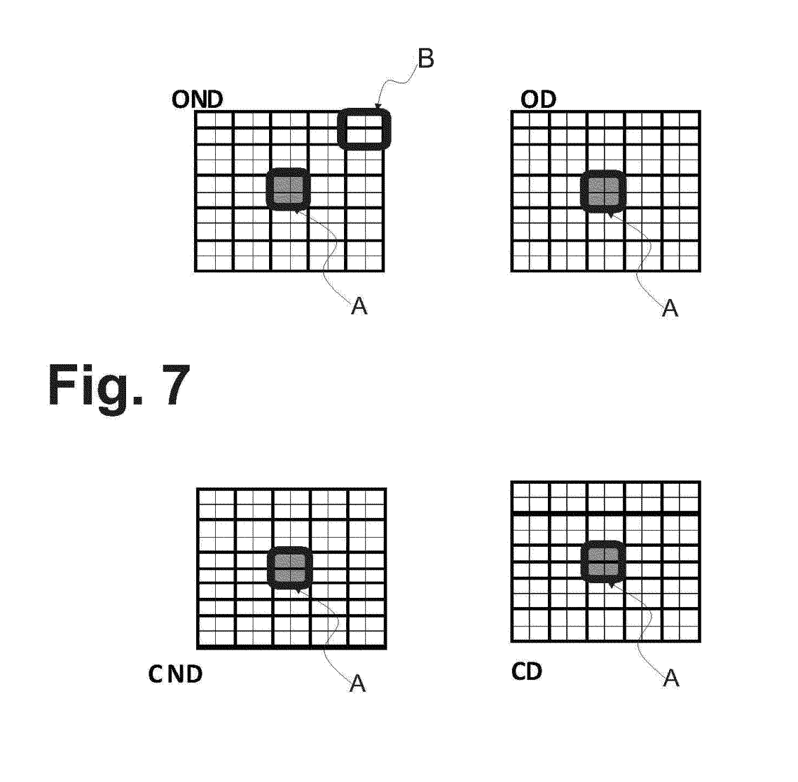

This approach, shown also in FIG. 7, aims to make the non-dominant view more similar to the dominant view based on a specified threshold. The original dominant is denoted with OD, original non-dominant is denoted with OND, to be converted dominant is denoted with CD and to be converted non-dominant is denoted with CND. Further, w is a weighting parameter (0<ω<1). By changing w in its range, it is possible to adjust the similarity extent of non-dominant view to dominant view. FIG. 7 shows, that each of the views (original non-dominant view OND, original dominant view OD, converted non-dominant view CND, converted dominant view CD) can be scanned in blocks of 2×2 pixels (being highlighted for example for OND with reference B). The following Error equation may be applied to each block:

Error=ω*abs((CND+CD)/2−OD)+(1-ω)*abs(CND−OND)/2+(1−ω)*abs(CD−OD)/2

where OD, OND, CD and CND are the average luma values of the respective 2×2 blocks (referred with A in each view OD, OND, CD and CND in FIG. 7). The term ω*abs((CND+CD)/2-0D) represents the error observed in viewing without glasses, whereas the terms (1−ω)*abs(CND−OND)/2+(1−ω)*abs(CD−OD)/2 jointly represents the error observed in viewing with shutter glasses. A minimization algorithm may be applied on Error equation by changing the values of CND and CD in the whole range of possible values.

The average luma value for a 2×2 block in the output images is obtained by solving the minimization problem for a 2×2 block. The ratio between OND and CND (for a 2×2 block) is then used to multiply the each luma pixel value in OND and the result is typically quantized to an integer value in the range of 0 to 255, inclusive. The potential quantization error may be randomly distributed onto the pixel values of the converted block such a way that the average luma value of the converted block becomes equal to CND.

A variety of non-dominant view presentations having different levels of similarity to dominant view can be generated with this method. By means of the parameter w, the final created views can be biased to satisfy more either single-view viewing without glasses (ω=1) or stereoscopic viewing with glasses (ω=0).

### (d) Low-Pass Filtering/Downsampling/Blurring

This approach modifies the spectrum of the non-dominant view in such as manner that high frequencies, i.e. sharp edges and details, become less perceivable and the non-dominant view becomes smoother. Any low-pass filtering method may be used, including but not limited to linear averaging. In addition to or instead of low-pass filtering, the images may be downsampled, and the downsampling operation may also include a low-pass filtering operation. In downsampling the number of samples of the image is reduced. Particularly if downsampling is not used together with half-toning, the images may be subsequently upsampled using, for example, bilinear or bicubic interpolation.

Analogously, the dominant view may be high-pass filtered, resulting into edges and details to become more pronounced. Any high-pass filtering method may be used. In some rendering systems, it may be possible to upsample the dominant view and render the dominant view such a manner that it comprises more pixels than the non-dominant view. Any upsampling method may be used including but not limited to super-resolution methods. In super-resolution methods, the non-dominant view and/or pictures from the dominant view may be used to enhance the spatial resolution of the dominant view. If the non-dominant view is used for upsampling, view synthesis methods may be used to project the non-dominant view to a virtual camera corresponding to the camera of the dominant view.

### (2) Display Configuration Adaptation (135)

The other adaptation method is a display configuration adaptation (135) (FIG. 4), which aims to favor the dominant view in displaying at the expense of the non-dominant view such a way that the stereo perception in viewing with glasses remain similar, but the dominant view is perceived more distinctly in viewing without glasses.

In the display configuration adaptation methods (135), the rendering of the left view and the right view can be modified such a manner that they are no longer being treated equally. The adaptation methods may include:

### a) Modifying the Timing of the Shutter Glasses and Display Refresh

In this method, the timing of the shutter glasses and display refresh can be modified such a manner that the dominant view gets displayed longer and/or more frequently compared to the non-dominant view. For example, the (picture) refresh rate of the display is 180 Hz and the content has 30 pictures per second. Consequently, in normal operation the same stereo pair is displayed for 6 refresh periods of the display in an alternating manner: the left-view picture is displayed for one display refresh period, then the right-view picture is displayed for the following display refresh period, followed by the same left-view picture displayed for one refresh period, and so on. In an adapted configuration of the display, the picture of the dominant view may be displayed for two refresh periods, followed by the picture of the non-dominant view displayed for one refresh period, followed by the same picture of the dominant view displayed for two refresh periods, followed by the same picture of the non-dominant view displayed for one refresh period, and then the next stereo pair is managed similarly. The shutter glasses can be operated in synchronization with the modified sequencing of the left-view and right-view pictures.

### (b) Display System Based on Polarization

When a display based on polarization is used, the polarization of the pixels on the display can be modified such a manner that the dominant view has a greater share of pixels when compared to the non-dominant view. The display system can be configured such a manner that the polarization of individual pixels or blocks or pixels is configured. The dominant view may be assigned with a greater number of pixels compared to the number of pixels for the non-dominant view. If the display system is capable of updating the polarization of each pixel, the pixel assignment between the dominant view and the non-dominant view may be done randomly or pseudo-randomly, but typically remains unchanged at least for the duration of a view sequence (from the beginning of a scene until its end).

### EXAMPLE

The present solution is described next by means of an example. Because the results of the solution can only be perceived on a stereoscopic display based on polarization or shutter glasses, the present example has been provided artificially by averaging the images of the left and right view, which resembles the image perceived when viewing an image form a stereoscopic display intended for shutter glasses but when no glasses are worn.

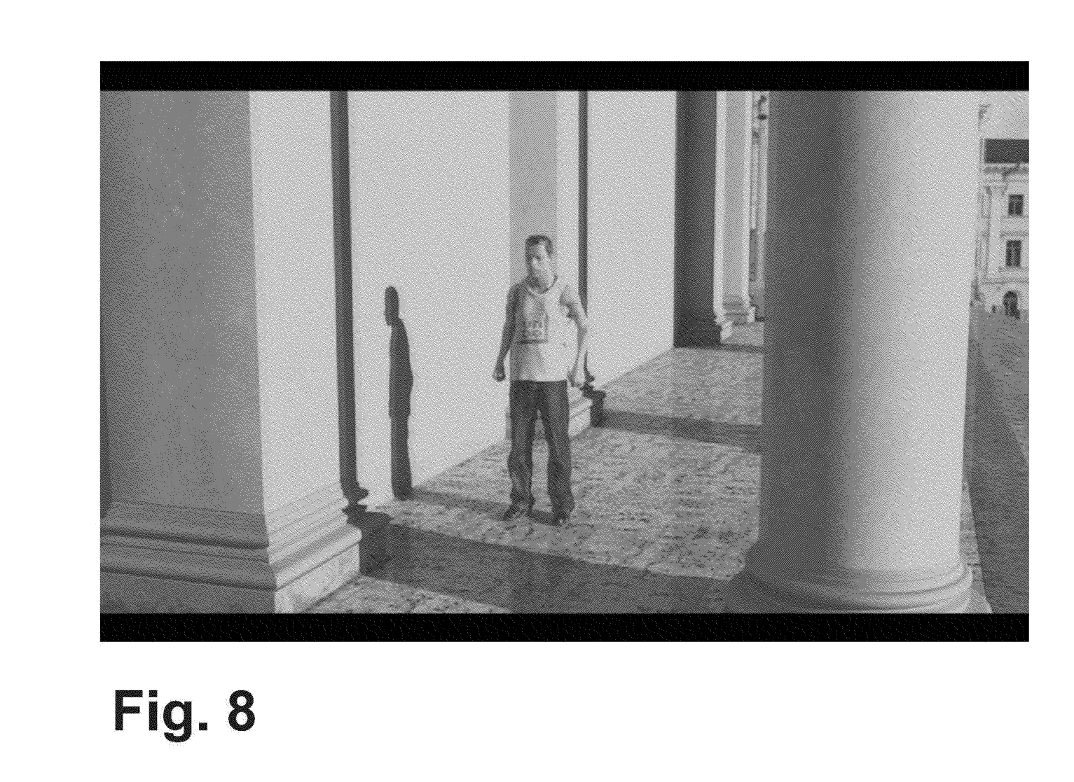

As said, FIG. 1 represents the original stereoscopic picture viewed without glasses. FIG. 8, on the other hand, represents an example of an adjusted stereoscopic picture viewed without glasses. While the shadow/ghost image has become tolerable in single-view viewing without glasses (FIG. 8), the human binocular vision still perceives three-dimensional pictures.

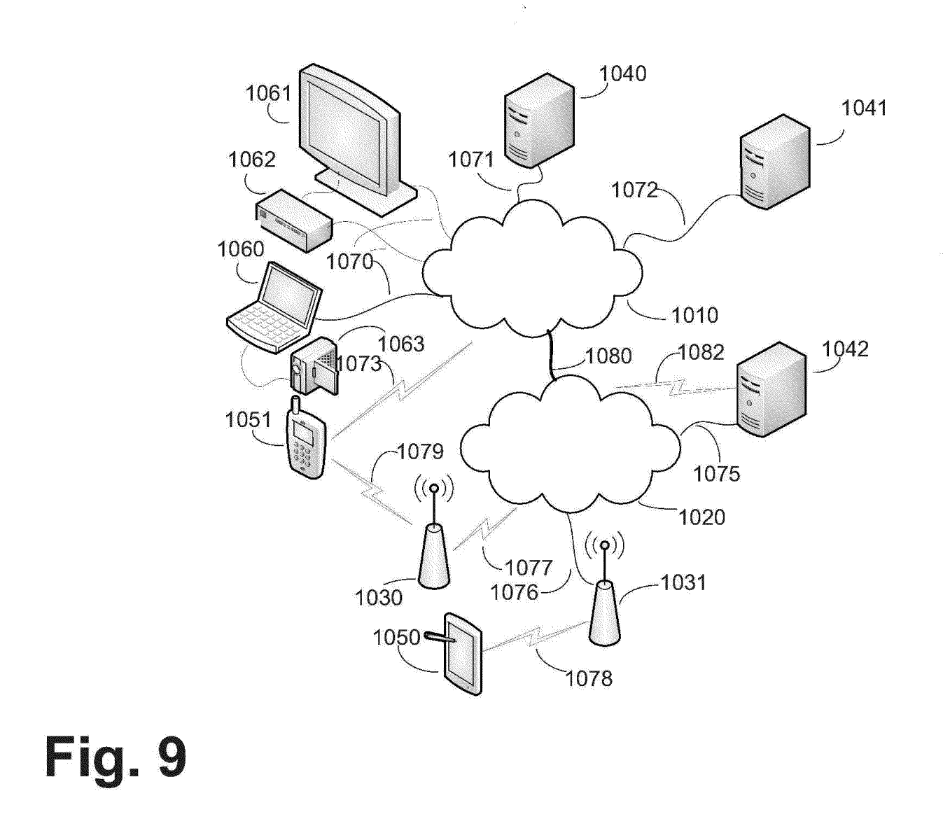

FIG. 9 shows a system and devices for a multi-view video system according to an embodiment. In FIG. 9, the different devices may be connected via a fixed network 1010 such as the Internet or a local area network; or a mobile communication network 1020 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 1080. The networks comprise network elements such as routers and switches to handle data (not shown), and communication interfaces such as the base stations 1030 and 1031 in order for providing access for the different devices to the network, and the base stations 1030, 1031 are themselves connected to the mobile network 1020 via a fixed connection 1076 or a wireless connection 1077.

There may be a number of servers connected to the network, and in the example of FIG. 9 are shown a server 1040 for offering a network service for providing multi-view (e.g. 3D) video and connected to the fixed network 1010, a server 1041 for storing multi-view video in the network and connected to the fixed network 1010, and a server 1042 for offering a network service for providing multi-view video and connected to the mobile network 1020. Some of the above devices, for example the computers 1040, 1041, 1042 may be such that they make up the Internet with the communication elements residing in the fixed network 1010.

There are also a number of end-user devices such as mobile phones and smart phones 1051, Internet access devices (Internet tablets) 1050, personal computers 1060 of various sizes and formats, televisions and other viewing devices 1061, video decoders and players 1062, as well as video cameras 1063 and other encoders. These devices 1050, 1051, 1060, 1061, 1062 and 1063 can also be made of multiple parts. The various devices may be connected to the networks 1010 and 1020 via communication connections such as a fixed connection 1070, 1071, 1072 and 1080 to the internet, a wireless connection 1073 to the internet 1010, a fixed connection 1075 to the mobile network 1020, and a wireless connection 1078, 1079 and 1082 to the mobile network 1020. The connections 1071-1082 are implemented by means of communication interfaces at the respective ends of the communication connection.

Yet another example of a system is a television broadcasting system operating through terrestrial, cable and/or satellite connection, a home AV (audio-visual) system comprising e.g. a television set or display, DVD (Digital Versatile Disc) player or similar, Internet connection, game console, remote controllers (for game console and/or device), and stereoscopic viewing glasses.

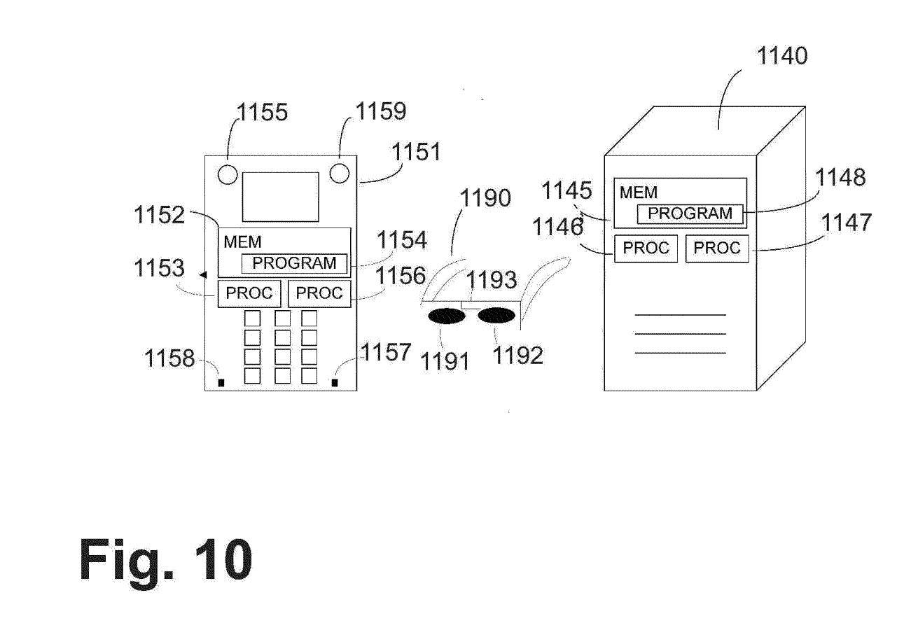

FIG. 10 shows a viewing device according to an example embodiment. As shown in FIG. 10, the server 1140 contains memory 1145, one or more processors 1146, 1147, and computer program code 1148 residing in the memory 1145 for implementing, for example, data encoding. The servers 1041, 1042, 1040 of FIG. 9, may contain at least these same elements for employing functionality relevant to each server. Similarly, the end-user device 1151 contains memory 1152, at least one processor 1153 and 1156, and computer program code 1154 residing in the memory 1152. The end-user device may also have one or more cameras 1155 and 1159 for capturing image data, for example stereo video. The end-user device may also contain one, two or more microphones 1157 and 1158 for capturing sound. The different end-user devices 1050, 1060, 1051, 1061 of FIG. 10 may contain at least these same elements for employing functionality relevant to each device. The end user devices may also comprise a screen for viewing single-view, stereoscopic (2-view), or multiview (more-than-2-view) images. The end-user devices may also be connected to video glasses 1190 e.g. by means of a communication block 1193 able to receive and/or transmit information. The glasses may contain separate eye elements 1191 and 1192 for the left and right eye. These eye elements may either show a picture for viewing, or they may comprise a shutter functionality e.g. to block every other picture in an alternating manner to provide the two views of three-dimensional picture to the eyes, or they may comprise an orthogonal polarization filter (compared to each other), which, when connected to similar polarization realized on the screen, provide the separate views to the eyes. Other arrangements for video glasses may also be used to provide stereoscopic viewing capability. Stereoscopic or multiview screens may also be autostereoscopic, i.e. the screen may comprise or may be overlaid by an optical arrangement which results into a different view being perceived by each eye. Single-view, stereoscopic, and multiview screens may also be operationally connected to viewer tracking such a manner that the displayed views depend on viewer's position, distance, and/or direction of gaze relative to the screen. For example, the viewer's distance from the screen may affect the separation of images for the left and right eye to form an image that is pleasing and comfortable to view.

It needs to be understood that different embodiments allow different parts to be carried out in different elements. For example, encoding and decoding of video may be carried out entirely in one user device like 1050, 1051, 1060 or 1151, or in one server device 1040, 1041, 1042 or 1140, or across multiple user devices 1050, 1051, 1060, 1151 or across multiple network devices 1040, 1041, 1042, 1140, or across both user devices 1050, 1051, 1060, 1151 and network devices 1040, 1041, 1042, 1141. For example, different views of the video may be stored in one device, the encoding of a stereo video for transmission to a user may happen in another device and the packetization may be carried out in a third device. As another example, the video stream may be received in one device, and decoded, and decoded video may be used in a second device to show a stereo video to the user. The video coding elements may be implemented as a software component residing on one device or distributed across several devices, as mentioned above, for example so that the devices form a so-called cloud.

The different embodiments may be implemented as software running on mobile devices and optionally on services. The mobile phones may be equipped at least with a memory, processor, display, keypad, motion detector hardware, and communication means such as 2G, 3G, WLAN, or other. The different devices may have hardware like a touch screen (single-touch or multi-touch) and means for positioning like network positioning or a global positioning system (GPS) module. There may be various applications on the devices such as a calendar application, a contacts application, a map application, a messaging application, a browser application, a gallery application, a video player application and various other applications for office and/or private use.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment. The various devices may be or may comprise encoders, decoders and transcoders, packetizers and depacketizers, and transmitters and receivers.

It is obvious that the present invention is not limited solely to the above-presented embodiments, but it can be modified within the scope of the appended claims.

1. A method comprising:
receiving a first picture and a second picture, the first picture and the second picture representing a left view and a right view, respectively, for stereoscopic viewing and intended to be rendered for left eye and right eye essentially simultaneously in stereoscopic viewing;
determining a dominant view from the left view and the right view and determining a non-dominant view from the left view and the right view, wherein the dominant view and the non-dominant view are not the same;
deriving a dominant picture based on the first picture and the second picture and the dominant view, and determining a non-dominant picture based on the first picture and the second picture and the non-dominant view;
adapting at least one of the content of or the rendering of at least one of the dominant picture and the non-dominant picture, wherein adapting the content of the dominant picture comprises at least one of the following group: high-pass filtering, upsampling, contrast enhancement, brightness enhancement; and adapting the content of the non-dominant picture comprises at least one of following group: contrast reduction, brightness reduction, low-pass filtering, subsampling, blurring, defocusing, and wherein adapting the rendering of the dominant picture comprises at least one of the following group: increasing the duration and/or frequency of displaying the dominant picture, increasing the number of pixels having a polarization of the dominant view; and adapting the rendering the non-dominant picture comprises at least one of the following group: decreasing the duration and/or frequency of displaying the dominant picture, decreasing the number of pixels having a polarization of the dominant view.

2. The method of claim 1, comprising determining whether adaptation of at least one of the first picture and the second picture is needed.

3. The method of claim 2, comprising rendering the adapted dominant picture and the adapted non-dominant picture essentially simultaneously as a response to determining that adaptation is needed.

4. The method according to claim 2, where determining whether the adaptation of at least one of the first picture and the second picture is done is based on detecting whether viewers wear stereoscopic viewing glasses.

5. The method according to claim 1, where determining a non-dominant picture comprises synthesizing the non-dominant picture on the basis of at least one of the first picture and the second picture.

6. The method according to claim 1, further comprising adjusting a disparity between the left view and the right view.

7. A system comprising:
receiving means configured to receive a first picture and a second picture, the first picture and the second picture representing a left view and a right view, respectively, for stereoscopic viewing and intended to be rendered for left eye and right eye essentially simultaneously in stereoscopic viewing;
determining means configured to determine, a dominant view from the left view and the right view and to determine a non-dominant view from the left view and the right view, wherein the dominant view and the non-dominant view are not the same;
and further to derive a dominant picture based on the first picture and the second picture and the dominant view, and determine a non-dominant picture based on the first picture and the second picture and the non-dominant view;
adapting means configured to adapt at least one of the content of or the rendering of at least one of the dominant picture and the non-dominant picture, where the adapting means is configured to adapt the content of the dominant picture by at least one of the following: high-pass filtering, upsampling, contrast enhancement, brightness enhancement; and to adapt the content of the non-dominant picture by at least one of following: contrast reduction, brightness reduction, low-pass filtering, subsampling, blurring, defocusing, and where the adapting means is configured to adapt the rendering of the dominant picture by at least one of the following: increasing the duration and/or frequency of displaying the dominant picture, increasing the number of pixels having a polarization of the dominant view; and to adapt the rendering of the non-dominant picture by at least one of the following group: decreasing the duration and/or frequency of displaying the dominant picture, decreasing the number of pixels having a polarization of the dominant view.

8. The system of claim 7, wherein the determination means are configured to determine whether adaptation of the first picture and the second picture is needed.

9. The system of claim 8, being configured to render the adapted dominant picture and the adapted non-dominant picture essentially simultaneously as a response to determining that adaptation is needed.

10. The system according to claim 7, where the system further comprises detecting means configured to detect whether viewers wear stereoscopic viewing glasses.

11. The system according to claim 10, where determining means for determining whether the adaptation of at least one of the first picture and the second picture is done are configured to operate according to an input from the detecting means.

12. The system according to claim 7, further comprising synthesizing means configured to synthesize the non-dominant picture on the basis of at least one of the first picture and the second picture for determining a non-dominant picture.

13. The system according to claim 7, further comprising adjusting means configured to adjust a disparity between the left view and the right view.

14. A viewing device comprising at least one processor, memory including computer program code, the memory and the computer program code configured to, with the at least one processor, cause the viewing device to at least:
receive a first picture and a second picture, the first picture and the second picture representing a left view and a right view, respectively, for stereoscopic viewing and intended to be rendered for left eye and right eye essentially simultaneously in stereoscopic viewing;
determine a dominant view from the left view and the right view and to determine a non-dominant view from the left view and the right view, wherein the dominant view and the non-dominant view are not the same;
derive a dominant picture based on the first picture and the second picture and the dominant view, and determine a non-dominant picture based on the first picture and the second picture and the non-dominant view;
adapt at least one of the content of or the rendering of at least one of the dominant picture and the non-dominant picture, where adapting the content of the dominant picture by at least one of the following: high-pass filtering, upsampling, contrast enhancement, brightness enhancement; and adapting the content of the non-dominant picture by at least one of following: contrast reduction, brightness reduction, low-pass filtering, subsampling, blurring, defocusing, and where adapting the rendering of the dominant picture by at least one of the following: increasing the duration and/or frequency of displaying the dominant picture, increasing the number of pixels having a polarization of the dominant view; and adapting the rendering of the non-dominant picture by at least one of the following group: decreasing the duration and/or frequency of displaying the dominant picture, decreasing the number of pixels having a polarization of the dominant view.

15. The viewing device of claim 14, wherein the computer program code is further configured to, with the at least one processor, cause the device to determine whether adaptation of the first picture and the second picture is needed.

16. The viewing device of claim 15, wherein the computer program code is further configured to, with the at least one processor, cause the device to render the adapted dominant picture and the adapted non-dominant picture essentially simultaneously as a response to determining that adaptation is needed.

17. A computer program embodied on a non-transitory computer readable medium, the computer program comprising instructions causing, when executed on at least one processor, at least one apparatus to:
receive a first picture and a second picture, the first picture and the second picture representing a left view and a right view, respectively, for stereoscopic viewing and intended to be rendered for left eye and right eye essentially simultaneously in stereoscopic viewing;
determine a dominant view from the left view and the right view and determine a non-dominant view from the left view and the right view, wherein the dominant view and the non-dominant view are not the same;
derive a dominant picture based on the first picture and the second picture and the dominant view, and determine a non-dominant picture based on the first picture and the second picture and the non-dominant view;
adapt at least one of the content of or the rendering of at least one of the dominant picture and the non-dominant picture, wherein adapting the content of the dominant picture comprises at least one of the following group: high-pass filtering, upsampling, contrast enhancement, brightness enhancement; and adapting the content of the non-dominant picture comprises at least one of following group: contrast reduction, brightness reduction, low-pass filtering, subsampling, blurring, defocusing, and wherein adapting the rendering of the dominant picture comprises at least one of the following group: increasing the duration and/or frequency of displaying the dominant picture, increasing the number of pixels having a polarization of the dominant view; and adapting the rendering the non-dominant picture comprises at least one of the following group: decreasing the duration and/or frequency of displaying the dominant picture, decreasing the number of pixels having a polarization of the dominant view.

18. A system comprising at least one processor, memory including computer program code, the memory and the computer program code configured to, with the at least one processor, cause the system to at least:
receive a first picture and a second picture, the first picture and the second picture representing a left view and a right view, respectively, for stereoscopic viewing and intended to be rendered for left eye and right eye essentially simultaneously in stereoscopic viewing;
determine a dominant view from the left view and the right view and determine a non-dominant view from the left view and the right view, wherein the dominant view and the non-dominant view are not the same;
derive a dominant picture based on the first picture and the second picture and the dominant view, and determine a non-dominant picture based on the first picture and the second picture and the non-dominant view;
adapt at least one of the content of or the rendering of at least one of the dominant picture and the non-dominant picture, wherein adapting the content of the dominant picture comprises at least one of the following group: high-pass filtering, upsampling, contrast enhancement, brightness enhancement; and adapting the content of the non-dominant picture comprises at least one of following group: contrast reduction, brightness reduction, low-pass filtering, subsampling, blurring, defocusing, and wherein adapting the rendering of the dominant picture comprises at least one of the following group: increasing the duration and/or frequency of displaying the dominant picture, increasing the number of pixels having a polarization of the dominant view; and adapting the rendering the non-dominant picture comprises at least one of the following group: decreasing the duration and/or frequency of displaying the dominant picture, decreasing the number of pixels having a polarization of the dominant view.
